(19) United States
(12) Patent Application Publication
(10) Pub. No.: US 2012/0265535 A1
(43) Pub. Date: Oct. 18, 2012

(54) PERSONAL VOICE OPERATED REMINDER SYSTEM

(76) Inventors: Donald Ray Bryant-Rich, Haifa (IL); Diana Eve Barshaw-Rich, Haifa (IL)

(21) Appl. No.: 12/876,206

(22) Filed: Sep. 6, 2010

Related U.S. Application Data
(60) Provisional application No. 61/240,257, filed on Sep. 7, 2009.

(51) Int. Cl. G10L 15/00

(52) U.S. Cl. 704/270; 704/E15.001

(57) ABSTRACT

A personal voice operated reminder system. In one embodiment, the system is worn as a device on the body in a form similar to a watch, bracelet or necklace. In another embodiment the system is a device normally held in a person's pocket or purse, and in another embodiment the system is a method added as an application to already existing devices such as PDAs or cellular telephones.

This device is configured to record reminders using speech recognition and to play back the reminder message in accordance with directions received using speech recognition, and/or position and/or motion inputs.

### FIELD OF THE INVENTION

This invention relates to reminding services, and more particularly to voice operated devices for creating reminders and rendering reminding services and/or position or motion based control inputs.

### BACKGROUND OF THE INVENTION

Poor memory is a common problem from which many people suffer. People forget many types of information ranging from simple activities they should do (“remember to buy milk on the way home”) to more complex activities, ideas or information. Memory problems become more common at the age of 50 when people start to experience Age Associated Memory Impairment (AAMI). Forgetting important information and activities is a source for fear and frustration for many people of all ages.

Many types of products and devices have been invented in order to overcome memory problems. Today most of these reminding products are applications for computer based devices such as PCs, laptops and PDAs. More recently these applications became available on mobile device such as cellular phones. One example of such application and probably the most popular one is Microsoft Outlook RTM software. This software provides calendar reminding services, and in addition appointment scheduling organizer and reminder. As this software is provided today in both computer and mobile devices, the reminder services are available for the user both when he is in the vicinity of his computer and as well as when he is away from it by his mobile device.

The known reminding applications utilize systems which either require hand control inputs such as keyboards or switches or are too large to conveniently wear. In a wearable voice reminder service the user can conveniently wear the voice reminder service at all times resulting in no lost reminders due to inaccessibility of the reminder service.

Moreover, the wearable voice reminder service may include hands-free control inputs to allow use of the voice reminder service when known reminding applications are unusable, for example for social, legal or safety reasons. Hands-free controls may include voice, position and/or motion based control input. Other sensor inputs may also be used to further refine the application and/or recognition of voice, position and/or motion based control inputs.

Recent advances in application specific integrated circuits, such as the Sensory RSC-4x series of speech processors⁶, have made it possible to provide compact and self contained devices utilizing speech recognition. Previously, the use of speech recognition required either significant computational resources with size and/or power requirements precluding the wearing of such devices, or communications to off-the-device computational resources for speech recognition. Use of off-the-device speech recognition is less than optimal since communications between the user's device, such as a Personal Digital Assistant or Cellular telephone and the speech processing center may be lost or unavailable, forcing the user to remember to enter a reminder later, removing much of the utility of such a system.

The method taught in this invention for use of position and/or motion based commands is different from existing methods in that it uses natural motions and/or positions to identify the intent of the user. Existing use of position and/or motion is based on arbitrary motions such as gestures, shaking and/or tapping. Gesture based user interfaces combine detection of motion and/or position with mapping the detected sensor inputs to commands^{1,2}. In order to simplify the recognition of gestures, the systems are configured to recognize a limited set of gestures and allow this set of gestures to be mapped to a configurable set of commands. Unfortunately, there is no direct association of the gestures, such as a wave, rotating the device in one plane or another, shaking the device, etc. to the associated command. One gesture is as good as another to invoke any given command. This requires the user to not only learn the acceptable gestures, but also to learn the association of the gesture to the assigned command. The use of shaking, such as in the Sansa Shaker³ wherein the device is shaken to randomly change the song played, also has no obvious connection between the action (shaking) and the resulting command (randomly change the song played). Other devices use tapping the device in various directions or recognition of foot⁴ and/or finger taps⁵ and again these devices do not provide an obvious association between the tapping and the resulting command.

The known reminding applications provide several types of reminding services as, for example, text, voice, and combinations of these, etc. In order to have a text reminder the user has to type the date, time and the reminding message. This information is saved in a text format and the reminding text is presented to the user when the date and time is due. Alternatively, the reminding text can be converted to voice and the message played with a computer generated voice.

### REFERENCES

1: Schlomer, Thomas, Benjamin Poppinga, Niels Henze, Susanne Boll, Gesture Recognition with a Wii Controller, Proceedings of the 2nd international Conference on Tangible and Embedded interaction, 2008

2: Moeslund, Thomas B. and Lau Norgaard, “A Brief Overview of Hand Gestures used in Wearable Human Computer Interfaces”, Technical report: CVMT 03-02, ISSN: 1601-3646, Laboratory of Computer Vision and Media Technology, Aalborg University, Denmark.

3: Anonymous, Sansa Shaker User's Manual, mp3support.sandisk.com/downloads/um/SansaShakerUserManual.pdf.

4: Fukumoto, Masaaki, Tapping Anywhere: A Position-free Wearable Input Device, http://www.nttdocomo.co.jp/english/binary/pdf/corporate/technology/rd/technical_journal/bn/vol9_{—}4/vol9_{—}4_{—}043en.pdf 5: Son, Yong-Ki, et al., Wrist-Worn Input Apparatus and Method, US Patent Application 2010/0066664.

6: Anonymous, RSC-464 Speech Recognition Processor, Sensory Inc., www.sensoryinc.com/support/docs/80-0282-M.pdf

### SUMMARY OF THE INVENTION

According to the present invention, there is provided a method for playing back a reminder message to a user comprising: receiving a reminder message by voice from the user; creating a rule for playing back the reminder message or a portion of it back to the user; and when the rule for playback is triggered, playing back the reminder message or a portion thereof to the user.

According to the present invention, there is also provided a system for playing back a reminder message to a user comprising: an voice input element configured to receive a reminder message by voice; a controller configured to create a rule for playing back the reminder message or a portion thereof to a user, the controller being also configured to determine when the rule is triggered; and an voice output element configured to output said reminder message or a portion thereof to the user when the rule is triggered.

The present invention can be a device that is worn on the wrist on the side opposite a watch, in place of a watch, or it can be part of a piece of jewelry such as a bracelet or necklace. This invention might also be held in a persons pocket or purse.

According to the present invention, the personal voice reminder system may be implemented in a multi-purpose device such as a cellular phone. The implementation may be in software or firmware using components also used by the cellular phone for telephony such as a microphone, speaker, display, storage element and controller. The implementation may also include the addition of one or more element not used by the cellular phone for telephony.

The invention may also use additional sensors such as those commonly present in certain cellular phones and other devices such as proximity sensors to refine the identification and/or recognition of voice, position and/or motion based control inputs. For example, one such control input commonly available in touch screen cellular phones is a proximity sensor used to detect the touch screens proximity to the users face. Normally this sensor input is used to disable the phone's touch screen input to prevent spurious commands from the touch screen touching the user's face. The same input may be used when the cellular phone in a position to accept an incoming call that it is in close proximity to the user's face as would be normally the case when the user wants to speak to another person using the cellular telephone. This use of the proximity sensor is complementary and opposite to the current and intended use of the proximity sensor to disable touch screen control inputs.

The rules for playing back the reminder will be normally extracted from the voice input allowing natural specification of both the reminder and the criteria for playing back the reminder in a single utterance. The words used to create the rule for playing back the reminder may be retained in the reminder to be played back for clarity or may be removed for brevity. If the utterance contains multiple time criteria, the complete utterance may be played back at each of the several times indicated by the criteria, allowing the user to resolve ambiguity in the utterance.

The rules for playing back the reminder may include additional criteria based on location and/or user activity. Location and/or user activity criteria may be used alone, used in combination with time criteria, or used to limit the application of time criteria in creating the rules for playback of the reminders.

Interaction with the reminder system may be controlled by common means such as buttons, taps or gestures or may be based on detected motions or positions of the reminder system. For example acceptance of reminders when the reminder system is moved to the user's mouth or in a position near the user's mouth, and analogously for playback of reminders when the reminder system is moved to the user's ear or in a position close to the user's ear.

### RELATED APPLICATION

This application claims the benefit of priority to U.S. provisional application having Ser. No. 61/240,257, filed Sep. 7, 2009, the specification of which is incorporated herein by reference in its entirety.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1A is a block diagram of a personal device based system for voice operated reminders, according to an embodiment of the present invention;

FIG. 1B is a diagram showing examples of reminders with the portions of the reminder identified.

FIG. 2 is a flowchart of a method for recording and playing back voice operated reminders, according to an embodiment of the present invention;

FIG. 3 is a flowchart of a method for incorporating user notification, automatic delays of reminders, playback of date and time, reminder triggered commands, according to an embodiment of the present invention; and

FIG. 4 is a flowchart of a method for allowing specification of commands in place of playback of a reminder, according to an embodiment of the present invention.

FIG. 5A is a block diagram of a personal device based system with additional elements allowing use of location and activity based rules for playback of reminders, and the creation of known locations and activities, according to an embodiment of the present invention;

FIG. 5A is diagram showing relative positions possibly used to determine the intended use of the reminder system, according to an embodiment of the present invention.

FIG. 6 is a block diagram of a position activated system, according to an embodiment of the present invention;

FIG. 7 is a representative grammar for reminder specification and commands.

### DETAILED DESCRIPTION OF EMBODIMENTS

Described herein are embodiments of the current invention for a personal voice reminder system. Examples of reminding capabilities include reminders based on time, location and/or activity.

As used herein, the phrase “for example,” “such as” and variants thereof describe non-limiting embodiments of the present invention.

Reference in the specification to “one embodiment”, “an embodiment”, “some embodiments”, “another embodiment”, “other embodiments”, “various embodiments”, or variations thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” “various embodiments”, or variations thereof do not necessarily refer to the same embodiment(s).

Unless defined otherwise, all technical and scientific terms used herein have the same meaning as commonly understood by one of ordinary skill in the art to which this invention belongs. Generally (although not necessarily), the nomenclature used herein described below are well known and commonly employed in the art.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it is appreciated that throughout the specification discussions, utilizing terms such as, “processing”, “computing”, “calculating”, “measuring, “determining”, “receiving”, “creating”, triggering“, “outputting”, “storing”, “playing”, “converting”, “attaching”, “using”, “translating”, or the like, refer to the action and/or processes of any combination of software, hardware and/or firmware.

Some embodiments of the present invention may use terms such as, processor, device, apparatus, system, block, client, sub-system, server, element, module, unit, etc, (in single or plural form) for performing the operations herein. These terms, as appropriate, refer to any combination of software, hardware and/or firmware configured to perform the operations as defined and explained herein. The module(s) (or counterpart terms specified above) may be specially constructed for the desired purposes, or it may comprise a general purpose computer selectively activated or reconfigured by a computer program stored in the computer. Such a computer program may be stored in a computer readable storage medium, such as, but not limited to, any type of disk including optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, any other type of media suitable for storing electronic instructions that are capable of being conveyed via a computing system bus.

The method(s)/algorithms/process(s) or module(s) (or counterpart terms specified above) presented in some embodiments herein are not inherently related to any particular electronic system or other apparatus, unless specifically stated otherwise. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The principles and operation of methods and systems for wearable voice operated reminding according to the present invention may be better understood with reference to the drawings and the accompanying description.

The personal voice reminder system 100 may be a dedicated device including any combination of software, firmware and/or hardware for providing reminder services, or the personal voice reminder system 100 may be an open platform device on which software is installed for providing reminder services. Examples of open platform personal devices include inter-alia: mobile devices (such as cellular phones, laptop computers, tablet computers, Personal Digital Assistants PDAs, etc) and non-mobile devices (such as public switched telephone network PSTN phones, desktop computers, etc). In one embodiment, the personal device includes inter-alia modules for speech processing, and reminding (including inter-alia storing and retrieving reminders, reminder criteria and/or rules for playback). In one embodiment, additionally or alternatively the personal device has location finding capabilities such as a global positioning system GPS receiver, and therefore the reminding module may allow location based reminders. In one embodiment, additionally or alternatively the personal device has position or motion finding capabilities such as an accelerometer or position sensor, and therefore the reminding module may allow motion or activity based reminders. In one embodiment, additionally or alternatively, the personal device includes a timing element (e.g. calendar/clock which shows current date and time, timer which counts down, etc), and therefore the reminding module may allow time based reminders.

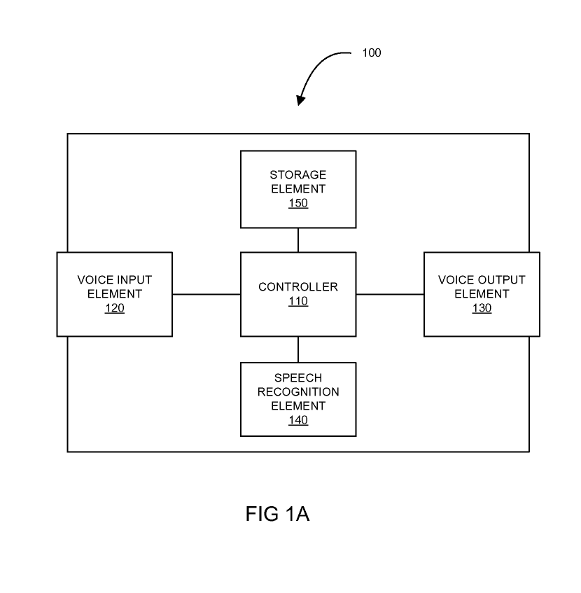

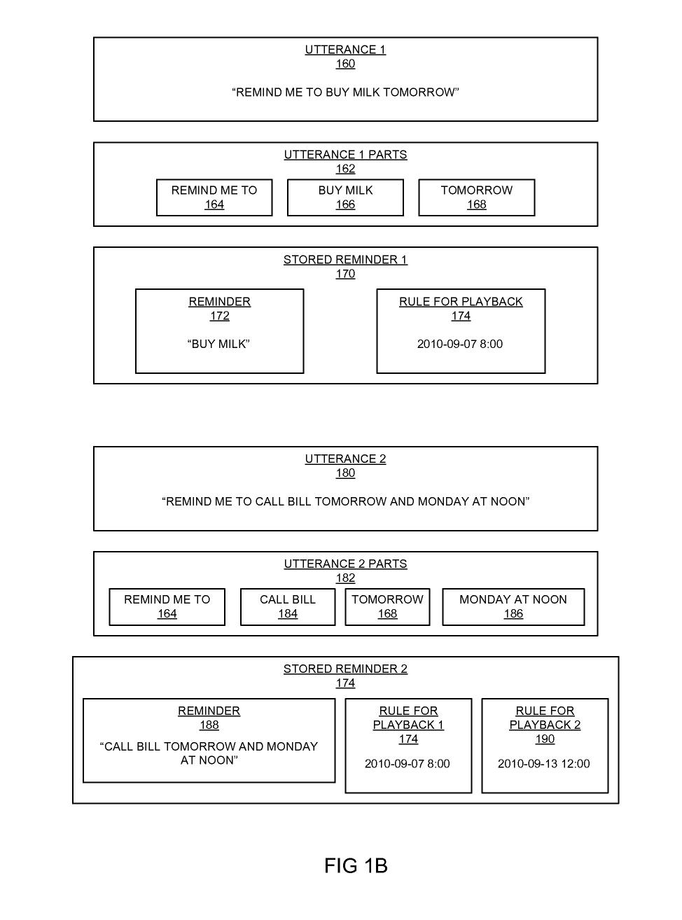

FIG. 1A illustrates personal voice reminder system 100 which is composed of various modules on a personal device, according to an embodiment of the present invention. Each module illustrated in FIG. 1A may be made up of any combination of software, hardware and/or firmware which performs the functions as defined and explained herein. For the sake of example, it is assumed that the personal device is a single purpose personal voice reminder system 100, although the invention is, of course, not limited to this example.

As illustrated in FIG. 1A, the personal voice reminder system 100 includes the following modules: a voice input element 120 such as a microphone, controller 110, a storage element 150, a voice output element 130 such as a speaker, and speech recognition system 140 capable of recognizing words relevant to commands and time specifications. In one embodiment, voice input element 120 allows for activation of the reminder system, for inputting reminding information and/or vocal commands. In one embodiment, controller 110, may have a large number of functions from which only part of them are described. For example, the first function may include the processing of the keyboard strokes and the consequent activation of the reminding service. For example the second function may include speech recognition for translating the relevant part of entered information (as explained below) to text. For example, the third function may include storing all the relevant information, as voice and/or text (as appropriate, see below) in the storage element 150. For example, the fourth function may include looking at the storage element 150 and periodically checking whether the needed rules for activating the reminding have been fulfilled, such as rules based on time, location, and/or activity or motion. Continuing with the fourth function, controller 110 may compare the time determined by the timer with times stored in storage element 150, and/or may compare the location determined by a Global Positioning System (GPS) module with the stored locations in storage element 150. For example, the fifth function may include notification of and/or outputting of the reminder message. In other examples, controller 110 may perform more, less and/or different functions than described above. In one embodiment the (voice) reminding information via voice is fed through voice input element 120, and the reminding message is played via the voice output element 130, however in other embodiments, the reminding message may be inputted via other inputting means and outputted via other means (for example via a remote provider of voice input and/or voice output such as a Bluetooth headphone, or hands-free phone system). In one embodiment, the processed reminding voice and/or text (as appropriate—see below) is stored at a storage element 150. In one embodiment, a GPS receiver continuously sends the device location to the processor for calculating whether the location rule has been fulfilled in case of a location reminder. In other embodiments, the voice operated reminding system on a cellular phone may comprise more, less and/or different modules than shown in FIG. 1A, and/or the functionality of the voice operated system may be divided differently among the modules. In some of these other embodiments, the modules and/or functionality on a different personal voice reminder system 100 may be similar or identical to the modules and/or functionality on a cellular phone.

FIG. 1B illustrates two example reminders with the parts of the reminder entered by the user identified with various options for storing the resulting reminder and rule or rules for playback. Reminder criteria, playback rules and rules for playback are used synonymously throughout this description. In general, each rule for playback is composed of one or more reminder criteria of any type (time, location, activity, etc.) and the reminder criteria can be combined using any combination of logical operations such as conjunction (“and”), disjunction (“or”) and negation (“not”).

The utterance entered by the user to the personal voice reminder system 100 to create a reminder will generally contain both information used to determine the reminder playback rule, equivalently a rule for playback or reminder rule, and the content of the reminder itself (what does the user need to be reminded of) as shown in block 160 for utterance 1 containing the phrase “Remind me to buy milk tomorrow”. A grammar or structure for reminders can be defined that allows the separation of these parts of the utterance. This grammar or structure can include words used to clearly separate utterances used to create reminders from voice commands, for example by starting reminder definition utterances by the words “Remind me to” as in this example or “Tell me to”. Use of such leading words may also allow the Speech Recognition Element 140 to change the set of words it recognizes from words used in commands (and of course the leading words) to words used to define reminder playback rules. In some implementations this may simplify the design of the personal voice reminder system 100 if the Speech Recognition Element 140 can only recognize a limited number of words, but the multiple sets of words recognized can be supported sequentially (i.e. after recognizing the leading words the “command and leading word” word set may be replaced by a “date and time specification” or “reminder playback rule” word set and this would then be reversed after analyzing the utterance to prepare for the next utterance.

In the first example, utterance 1 [160] may be separated into the utterance parts 162 containing the reminder indicating prefix “Remind me to” 164, the actual event or reminder that the user wants to remember, in this example “buy milk” 166 and the words used to define the playback rule, in this case “tomorrow” 168.

The separated parts may be stored in many different ways without changing the fundamental aspects of the invention. One such exemplary storage is shown in block 170. Here only the reminder phrase “buy milk” is stored as the reminder 172. The reminder phrase may be stored in many ways such as text or voice. Note that the contents of the reminder phrase do not need to be understood by the speech recognition element 140 since the contents of the phrase might only be stored and played back to the user. The rule for playback 174 is stored as a time value rendered from the time specification word “tomorrow” using a specification to start reminding a user at 8 AM on any day where the time of day was not specified. Therefore if the reminder “Remind me to buy milk tomorrow” 160 is stored on Sep. 6, 2010, the value of “tomorrow” 168 will be converted into a rule for playback 174 to remind the user at 8:00 on Sep. 7, 2010. Other relative or imprecise date and time specifications such as “day after tomorrow”, “next week”, “next Monday”, “tomorrow afternoon”, etc. can similarly be converted to precise times at which to start reminding the user. If the reminder is provided at an inconvenient time the user can delay or discard the reminder or record a new reminder with a more convenient rule for playback specification. While in the example presented only the words not used to start a reminder (“Remind me to”) or used to specify the rule for playback (“tomorrow” in this example) are stored (“buy milk” in this example), other options can be provided. For example, the whole utterance might be stored for playback to use the start of reminder phrase to distinguish a reminder from other voice output, or to store both the reminder phrase (“buy milk” in this example) and the words used to specify the rule for playback (“tomorrow” in this example) resulting in a stored reminder of “buy milk tomorrow”.

In the second example, utterance 2 [180], “Remind me to call Bill tomorrow and Monday at Noon” may be separated into the utterance parts 182 containing the reminder indicating prefix “Remind me to” 164 as in the first example, the actual event or reminder that the user wants to remember, in this example “call Bill” 184 and the words used to define the playback rules, in this case “tomorrow” 168 and Monday at Noon” 186.

As in the first example, the reminder may be stored in many ways with the complete reminder “Call Bill tomorrow and Monday at Noon” shown in this example 188. As two distinct rules for playback were present in utterance 2 (“tomorrow” 168 and “Monday at Noon” 186) two rules for playback (174 and 190) are stored for the same reminder 188. Therefore the reminder is created on Sep. 6, 2010, this example reminder will be played back to the user both starting at 8:00 AM on Sep. 7, 2010 as specified by “tomorrow” (rule for playback 174) and on September 13^{th} , 12 Noon (rule for playback 190). Since the reminder has multiple rules for playback (174 and 190) completing one task as indicated by a command of perhaps “Reminder done” will only remove the rule for playback used to trigger playback and only after the last rule for playback associated with the reminder is removed will the reminder itself (188) be removed from the personal voice reminder system 100. Similarly, periodic or recurring reminders (for example, “call home every day at 5 PM”) can be treated as a reminder with a series of rules for playback generated each time the preceding rule for playback is triggered. For example, the example reminder of “call home every day at 5 PM” would create a playback rule for “17:00” on the day it was created (if it was created before 17:00) or for the next day (if created on or after 17:00). When this first playback rule is triggered, another playback rule for 17:00 the day after would be created for the same reminder to provide recurrence or repetition. This would also allow the current rule for playback to be modified to delay playback of the reminder for today and allow deletion of the rule for playback for today without deleting the reminder. Deletion of the reminder, as opposed to deletion of a single rule for playback instance, would require a separate command such as “Remove reminder recurrently”.

The separated parts may be stored in many different ways without changing the fundamental aspects of the invention. One such exemplary storage is shown in block 170. Here only the reminder phrase “buy milk” is stored as the reminder 172. The rule for playback 174 is stored as a time value rendered from the time specification word “tomorrow” using a specification to start reminding a user at 8 AM on any day where the time of day was not specified. Therefore if the reminder “Remind me to buy milk tomorrow” is stored on Sep. 6, 2010, the value of “tomorrow” will be converted into a rule for playback to remind the user at 8:00 on Sep. 7, 2010. Other relative or imprecise date and time specifications such as “day after tomorrow”, “next week”, “next Monday”, “tomorrow afternoon”, etc. can similarly be converted to precise times at which to start reminding the user. If the reminder is provided at an inconvenient time the user can delay or discard the reminder or record a new reminder with a more convenient rule for playback specification. While in the example presented only the words not used to start a reminder (“Remind me to”) or used to specify the rule for playback (“tomorrow” in this example) are stored (“buy milk” in this example), other options can be provided. For example, the whole utterance might be stored for playback to use the start of reminder phrase to distinguish a reminder from other voice output, or to store both the reminder phrase (“buy milk” in this example) and the words used to specify the rule for playback (“tomorrow” in this example) resulting in a stored reminder of “buy milk tomorrow”.

For ease of understanding, methods 200 and 300 are now described using a personal voice reminder system 100 as an example of a personal voice reminder system 100. As explained above, however, other types of personal devices may be used instead.

Unless otherwise stated, methods 200 and 300 described below may be implemented using a single purpose personal voice reminder system 100, or any other appropriate system providing elements equivalent to those comprising personal voice reminder system 100.

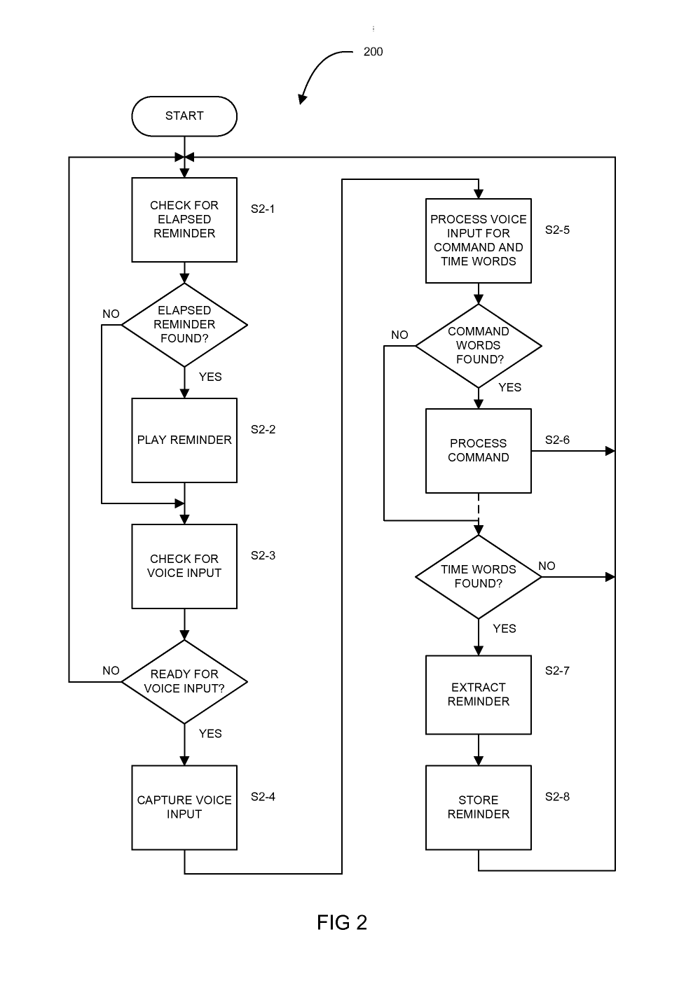

FIG. 2 illustrates method 200 for inputting, storing and playback of reminder messages, according to the embodiment of the present invention. In other embodiments, method 200 may include fewer, more, and/or different stages. In other embodiments, stages shown as sequential in method 200 may be performed in parallel and/or stages shown as being performed in parallel may be performed sequentially.

In the illustrated embodiment, the reminder system is activated periodically or repeatedly. The personal voice reminder system 100 first checks for elapsed reminders. An elapsed reminder is a reminder for which the associated time has passed. If an elapsed reminder is found, the reminder is played in step S2-2 using the voice output element 130.

If no elapsed reminder is found, or after playing an elapsed reminder, the personal voice reminder system 100 checks if the user is ready to enter voice input. For example, the user may raise the personal voice reminder system 100 to a speaking position or make an equivalent motion, press a button, or make a gesture to indicate their readiness to enter voice input. Alternatively, the device may recognize when the user is speaking and start the process of capturing voice input as soon as the user speaks into the voice input element 120. The process of checking for user input may incorporate a delay to allow a certain amount of time for the user to enter voice input. For example, the user might be given 10 seconds in which to start providing voice input and only upon the elapse of the time (10 seconds in this example) would the decision that no voice input is available be determined.

The user's voice input is captured in step S2-4 and processed using speech recognition element 140 in step S2-5 for command and time words.

If command words, such as “delete”, “done”, “delay”, “wait”, are found in the voice input the rest of the voice input is processed for parameters to the command and the command is processed in step S2-6.

If the voice input was not recognized as a command a check for time words is made. Time words are words which indicate a relative or absolute time. Time words may indicate a specific time, such as “noon” or “two”, relative times such as “in two hours”, “in twenty minutes”, or general times such as “this evening”, “tomorrow”, and “next week”. Time words may also be user defined such as by equating “on the way home” with “five thirty PM” where the user generally starts to go home at 5:30 PM.

In some embodiments, instead of returning to check for elapsed reminders after processing a command in step S2-6, a check for time words may also be made if warranted by the command. For example, if the command is to “delay” it may be necessary to examine the words found in step S2-5 for the time or interval to delay the reminder.

If time words are found the time words are used to create an absolute or differential time to replay the reminder depending on whether the personal voice reminder system 100 has a real time clock or just counts down the time to the reminder. The reminder is stored in step S2-8 in the storage element 180 for use in subsequent steps S2-1 and S2-2.

The full voice sequence captures in step S2-4 may be stored for playback as the reminder, or the portion not containing time words may be extracted in step S2-7 for recording. In either case the reminder may be stored as all or a portion of the voice recording captures in step S2-4, or may be stored as text extracted from the voice recording in step S2-5. If the reminder is stored as text the reminder may be played back by conversion of the text to speech or by display of the text on a textual display instead of as voice playback through voice output element 130.

In one embodiment the user will additionally or alternatively be able specify absolute times for reminder activation. For example, the speech might be “call Bill on March first at three in the afternoon”. In one embodiment the user will additionally or alternatively be able specify relative times for reminder activation. For example, the speech might be “call Bill at three tomorrow”. In one embodiment the user will additionally or alternatively be able specify approximate times for reminder activation. For example, the speech might be “call Bill tomorrow”. In one embodiment the user will additionally or alternatively be able specify personal times for reminder activation. For example, the speech might be “buy milk on the way home” wherein the time “on the way home” has been defined.

In one embodiment the user will additionally or alternatively be able to specify multiple times, locations and/or activities for activation of the reminder wherein the reminder will be associated with each time, location and/or activity for playback when any of the times, locations and/or activities are matched by the current time, device location or user activity.

In one embodiment the user will additionally or alternatively be able to specify multiple times, locations and/or activities for activation of the reminder wherein the reminder will be associated with all times, locations and/or activities for playback when all of the times, locations and/or activities are matched by the current time, device location or user activity.

In one embodiment the user will additionally or alternatively be able to specify multiple times, locations and/or activities for activation of the reminder wherein the user specifies a set of conjunctive (“and”), disjunctive (“or”) and/or negation (“not”) operations for determining the possible sets of times, locations and/or activities for playback of the reminder.

The commands processed in step S2-6 will generally be related to management of the reminders stored in storage element 150. After a reminder is played, the user enter voice commands to delete the reminder (e.g. “done”, “delete”, “remove”) or to delay the reminder to a more convenient time (e.g. “reschedule to . . . ”, “delay for . . . ”, “repeat at . . . ”, “wait”, “snooze”). As indicated by ellipsis above, the command may include time words used to indicate the new reminder time or the delay in replaying the reminder.

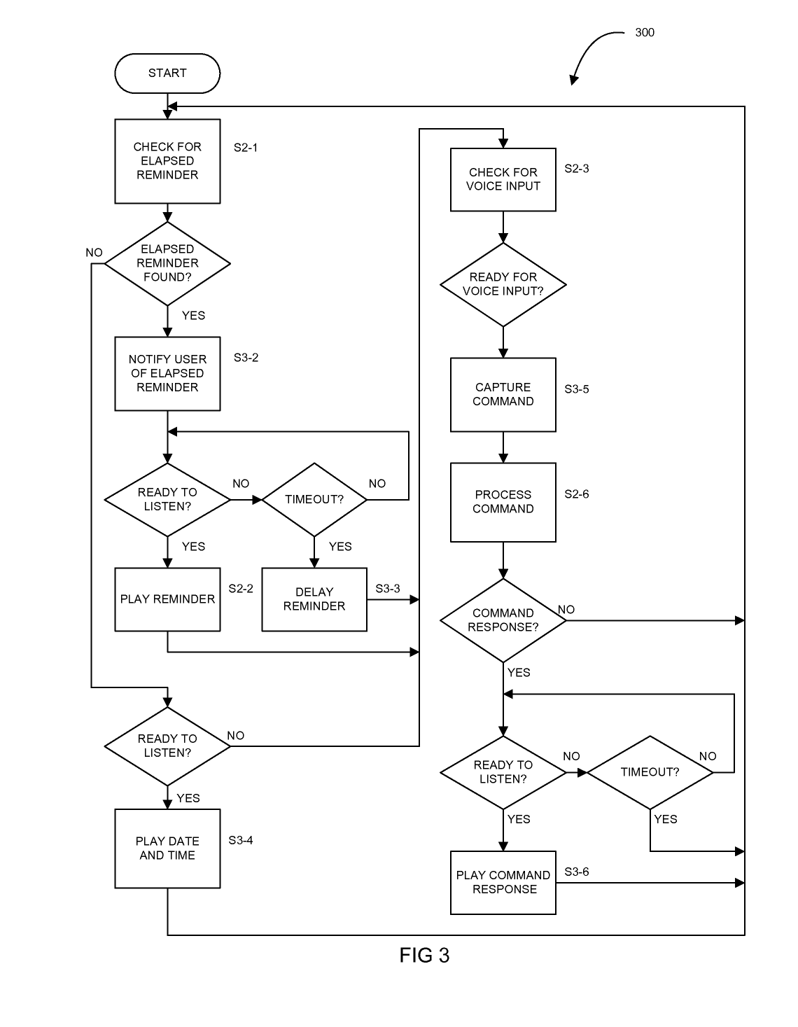

FIG. 3 elaborates on sections of the flow diagramed in FIG. 2. Specifically, the ability of the personal voice reminder system 100 to use a notification element to notify the user, perhaps by use of light, vibration, sound, tone or buzz, that a reminder has elapsed, to automatically delay of reminders if the user is not ready to listen to them, use of the personal voice reminder system 100 as a talking clock, and voice responses to commands. In other embodiments, stages shown as sequential in method 300 may be performed in parallel and/or stages shown as being performed in parallel may be performed sequentially.

In FIG. 3, after an elapsed reminder has been found in step S2-1, the user is notified of the elapsed reminder perhaps by means of notification element using for example light, vibration, sound, tone or a buzz, before playback of the reminder to allow the user to move the personal voice reminder system 100 to their ear, to enable a Bluetooth headset, or otherwise to prepare for playback of the reminder in some other way. In FIG. 3 playback of the reminder in step S2-2 is done only after the user is ready to listen to the reminder, for example, as indicated by the position of the personal voice reminder system 100, establishment of communications to a wireless headset, or a button is pressed. If a timeout period has elapsed the reminder may be automatically delayed for some time in step S3-3. The delay may be a constant time, such as fifteen minutes, or may be relative to the delay between the creation of the reminder and the reminder time, or relative to the precision of the time words used to set the reminder. For example, the delay may be some proportion of the time between the creation of the reminder and when the reminder elapsed, or may be one minute for reminders set in terms or minutes or hours, one hour for reminders set in terms of days, one day for reminders set in terms of weeks, etc. The values of one minute, one hour or one day are representative and other values or ranges of values may be used.

FIG. 3 expands on the command processing of FIG. 2 with the addition of possible responses to commands. After a command is captured in step S3-5, equivalent to step S2-5 and the subsequent decision in FIG. 2, and the command is processed in step S2-6, at test is made for a response to the command. If a response is available the personal voice reminder system 100 waits for the user to be ready to listen to the response and plays it if the user is ready to listen to the response before a timeout. The response is played in step S3-6. Determination of the user's readiness to listen is discussed above.

FIG. 3 neglects the entry of reminders for simplicity only.

In FIG. 3 the personal voice reminder system 100 may also be used as a talking clock by allowing the device to check for the user indication of being ready to listen even when no elapsed reminders are found in step S3-4. If the user indicates that they are ready to listen, for example by moving the personal voice reminder system 100 to their ear, it would respond by playing the time and date or with or without also playing back the next reminder to be given if any.

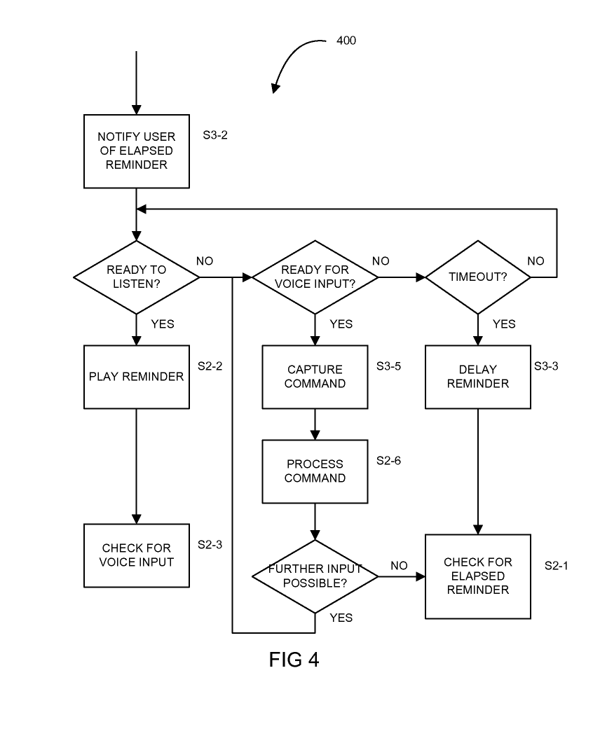

FIG. 4 elaborates on the processing after an elapsed reminder is found in FIG. 3. by allowing the user to enter voice commands relevant to the notification of the elapsed reminder. Such commands may be used to cancel or delay the reminder without listening to the reminder.

FIG. 4 neglects the entry of reminders for simplicity only.

In FIG. 4 the personal reminder system 100 also checks for voice input after playback of a reminder in order to allow the user to respond to the reminder by voice command without listening to the reminder. In many cases the user may want to delay or otherwise process a reminder without regard to the specific contents of the reminder. For example, while in a meeting the user might want to delay all reminders until after the end of the meeting by responding to any reminder with a command of “delay until three PM”. The steps shown are as described for FIG. 2 and FIG. 3. If the command entered in step S3-5 allows for additional processing of the reminder the flow may be from Step S2-6 back to the loop of Ready to Listen, Ready for Voice Input and Timeout, otherwise the flow may be directly to step S2-1 to wait for the next matched reminder playback rule.

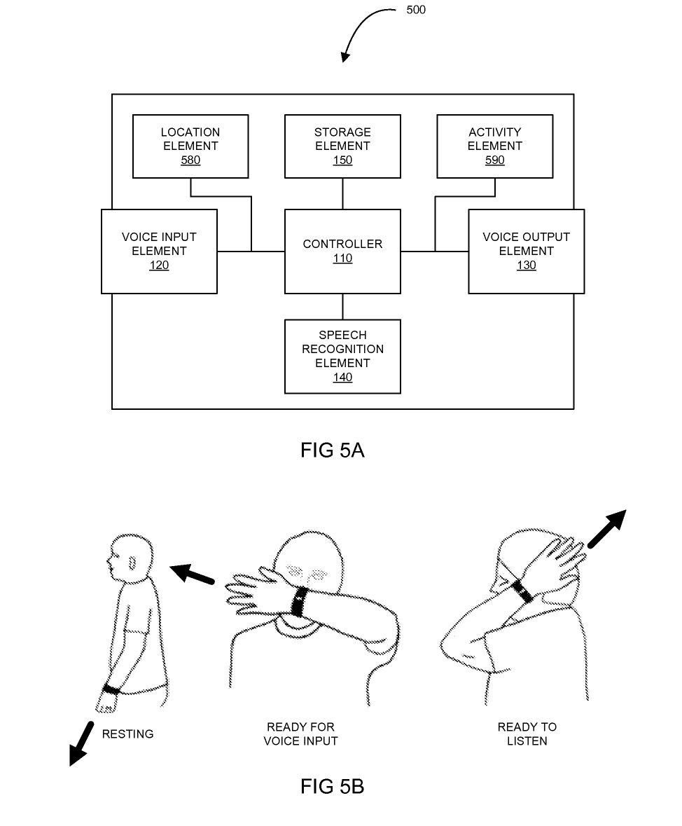

FIG. 5A elaborates on the personal voice reminder system 100 of FIG. 1A by incorporating additional element used to capture the location and activity of the user. The location element 580 could be a GPS receiver, inertial tracker or other means of determining the position of the personal voice reminder system 100 and equivalently the user. The activity element 590 may be an accelerometer, motion sensor, vibration sensor, or other means of determining the activity of the user. Addition of location element 580 and/or activity element 590 allows the personal voice reminder system 100 to create reminders based on location, position and/or activity. For example, a reminder may be activated (elapses) when the user reaches a specific location or area (e.g. “call Bill when I get home” associated with the location “home”) or activity (e.g. “buy milk on the way home” associated with driving through a rule that “on the way home” equates to driving between 5:00 PM and 6:00 PM.

Addition of location and activity allows for the creation of reminders that incorporate both time and other element. An example was used in the previous paragraph to equate a time range (5:00 PM to 6:00 PM) and an activity (“driving”) with a reminder activation (“on the way home”).

The addition of an activity element may also be used as discussed in reference to FIGS. 2 to 4 to determine the user's readiness to listen to a reminder or to enter a voice input by detection of either the position of the personal voice reminder system 100 (next to the user's ear, in front of the user's mouth) or by detection of the motion of the device to such positions, or by recognition of gestures.

Such activities can be trained into the personal voice reminder system 100 by invoking a command to start the gathering of position and/or motion inputs followed by a command to stop this accumulation of inputs, analysis of the gathered position and/or motion inputs into a pattern that can be used to recognize the activity and storing the activity pattern for use in creating future reminder playback rules. For example, if the user invokes a command to “Learn driving activity” when starting to drive, the position inputs might reflect the user's hand position on the steering wheel and motion inputs might reflect the vibration of the car from its engine and the road, side to side accelerations from turning and forward/backward accelerations from accelerating and braking the automobile respectively. Combined these position and/or motion inputs may then provide a recognizable patter that can be used to detect “driving” for use in reminders such as “remind me to check the engine light when driving”. Activities may be easily distinguished from position and/or motion commands by their duration. Activities commonly represent repeated or similar positions and/or motions over a period of time ranging from about a minute to many minutes. Position and/or motion based commands are in distinction short in duration since command inputs are constrained by user behaviors to a few seconds. In general, if a command takes more than a few seconds, perhaps as little as 10 seconds, to perform users will prefer alternative methods to enter the command. Activities do not have a similar constraint as they are performed for reasons other than to command the personal voice reminder system 100 of similar device.

FIG. 5B exemplifies the use of personal voice reminder system 100 position to detect “ready to listen” or “ready for voice input” conditions. If the personal voice reminder system 100 is attached to the inside of the of the user's wrist it will be oriented in the direction indicated by the bold arrows when held next to the user's mouth or ear. Similar differences may be detected if the device is attached to other parts of the body or held in the user's hand. For example, if the device is worn as a pendant, the idle position would be with the clasp of the pendant up and the face away from the body, but when ready to receive voice input the clasp would be down (the pendent will normally be reversed when lifted to towards the user's mouth) and would be closer to horizontal when positioned close to the user's ear in expectation of a voice output.

In one embodiment, the speech may contain commands to the personal voice reminder system 100 to create new elements used to set reminder conditions. For example, the user may say “learn driving activity” when starting to drive and say “end driving activity” some time later to command the personal voice reminder system 100 to capture motion data for use in defining a driving activity. This captured, and possibly processed, motion data would allow the use to specify an activity as “driving”, for example, by saying “text Bill at six if not driving”. The same method may be used with location input to allow the user to define locations for location based reminders. For example, the user could start to drive home and say “store market location” as they approach the store. This would allow the personal voice reminder system 100 to store the location and direction of motion for matching as “the market”. This could be used to create a reminder using a phrase such as “buy milk when at the market”. The reminder “buy milk” would be activated when the user's location, speed and direction match the location and direction stored as “the market”.

Such locations can be trained into the personal voice reminder system 100 by invoking a command to associate the current location of the device with a named location stored by the device for use in defining reminder playback rules. The location stored may be further modified to include a neighborhood indication since generally the exact location to the resolution of the location element's reported data is not required, but a location that is close to the recorded location is sufficient for use in the reminder playback rule. The neighborhood may be future refined by adding additional points associated with the same name as the original point or points, for example by adding more locations as “home” the user for example might expand the area of the “home” location to include the users whole home and possible their yard as well. Counter examples may be used, for example by a command such as “learn location not home” to exclude the current location of the personal voice reminder system 100 from the “home” location to better fit the user's concept of “home”, for example to exclude an apartment above or below the user's apartment from the “home” location. Similar techniques such as staring the recording of a path or loop to be used as the definition of a path like location or a location defined by the area enclosed by the loop of positions retrieved from the location element. Path like locations may be used to define reminders with playback rules such as “remind me to buy milk when on the road home” which uses a path location of “the road home”. Such path locations can be defined easily by storing a sequence of points and applying a neighborhood of close enough locations as described above for a single point to matching the location. Creation of closed loops having an interior and exterior from a sequence of points, in this case positions retrieved from the location element when defining an area location, is well known in the state of the art.

Reminders may be stored in storage element 150 in various ways clear to a normal practitioner of the art. For example, reminders may be stored in order of creation and searched for the next reminder to be activated or may be stored in order of their time to be activated in order. Reminders may also be liked to multiple conditions of time, location, activity, etc. to allow matching the reminder to the current time, the current location and/or the current activity.

It should be noted that depending on the embodiment, the user who entered the reminder may be notified of the reminder through the same personal voice reminder system 100 that was used to input the reminder, may be notified at a different personal voice reminder system 100, and/or a user different than the user who inputted the reminder may be notified of the reminder. It should also be noted that depending on the embodiment, only one personal voice reminder system 100 may be used to output a reminder message or a plurality of personal voice reminder system 100 may output the same reminder message (with the plurality of devices belonging for example to the same user and/or to different users). For simplicity of description of a personal voice reminder system 100 it is assumed that one user is notified per reminder message via one personal voice reminder system 100.

The processing of commands has described the delay of reminders by command or automatically if the user does not indicate readiness to listen. Other commands may be implemented to create periodic reminders: adding this feature in one embodiment will allow the user to add a key word (a word that is being used for checking whether the rules for message are due). For example a repeated message may be “call home at three PM every day”. This message will generate a reminder notification every day at 3:00 PM with a recorded reminder of “call home”.

In another embodiment, the voice input may contain additional conditions to be applied to a reminder after playback of the reminder. For example, “delay until not driving” could be used to indicate that a played reminder needs to be delayed because the user can not respond because they are currently driving. Responding to a reminder requiring the use of a text messaging device or cellular phone where the use of such devices while driving is forbidden by law until driving has stopped would be an example of the utility of such a delay.

In the described embodiments the primary example for input is the use of voice input and the primary example of output is voice output. Alternative or additional embodiments may use other or additional means of input and output. For example, the addition of a keypad or the use of an existing keypad for text entry could allow for entering reminders and commands when voice input is precluded due to noise, activity, social conditions or other reasons. Similarly, the addition of a textual display allows for the output of reminders as text where voice output is precluded due to noise, activity, social conditions or other reasons. The addition of text based input and output may also allow for the addition of text to speech and speech to text to allow full convertibility of both voice and text input with both voice and text output. In some embodiments, both text and voice output may be done serially or concurrently.

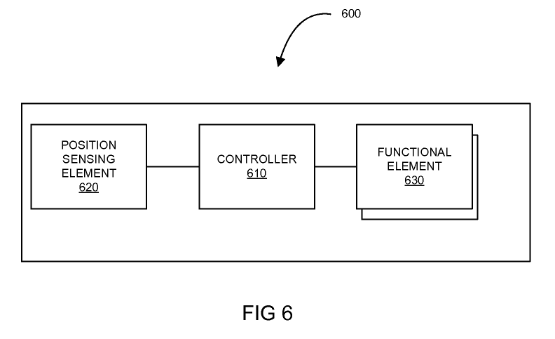

FIG. 6 illustrates position activated system 600 which is composed of various modules on a personal device, according to an embodiment of the present invention. Each module illustrated in FIG. 6 may be made up of any combination of software, hardware and/or firmware which performs the functions as defined and explained herein. For the sake of example, it is assumed that the personal device is a single purpose position activated system, although the invention is, of course, not limited to this example.

As illustrated in FIG. 6, the position activated system 600 includes the following modules: a controller 610, a position sensing element 620 and one or more functional elements 630. In one embodiment, controller 610 receives position information from position sensing element 620 and uses this information to control functionality implemented in one or more functional element 630 such as activating, enabling or disabling the functional element 630 or a portion of the functional element 630. In one embodiment, controller 610, may have a large number of functions from which only part of them are described. In one embodiment the controller 610 may implement one or more functional elements with or without additional separate functional units 630.

The control of functional units 630 is associated with positions sensed by the positional sensing element 620 to allow functionality normally associated with the positions. For example, a position activated system 600 with additional time keeping and voice output elements may invoke voice output of the date and time when the position activated system 600 is placed in a position appropriate for listening to the voice output. For example, a position activated system 600 with additional elements common to cellular telephones may answer an incoming phone call when the position activated system 600 is placed in a position appropriate for listening to phone call. For example, a position activated system 600 with additional elements common to digital cameras may invoke image capturing when the position activated system 600 is placed in a position appropriate for framing the scene to be captured as an image.

As described above for the personal voice reminder system 100, the position activated system 600 may provide a means by which commands may be entered to the position activated system 600 to create new identified positions and/or motions used to enter commands.

This method of using position and/or motion based command inputs is applicable to any device that has positions or motions associated with use distinct from the normal positions or motions associated with non-use (idle or between active uses). Motions can often be used where position alone is insufficient to differentiate between use and non-use positions where the device is in the same static position but the transition between the positions can be detected as a motion, for example if a camera is in the same or similar position when hanging from a neck strap and when taking a picture but the motion of raising the camera can be used to detect the transition to use and the motion of lowering the camera can be used to detect the transition to non-use. As discussed above, additional sensor or control inputs can also be used to refine the position and/or motion inputs to enable differentiation of use and non-use or between various use position and/or motion inputs.

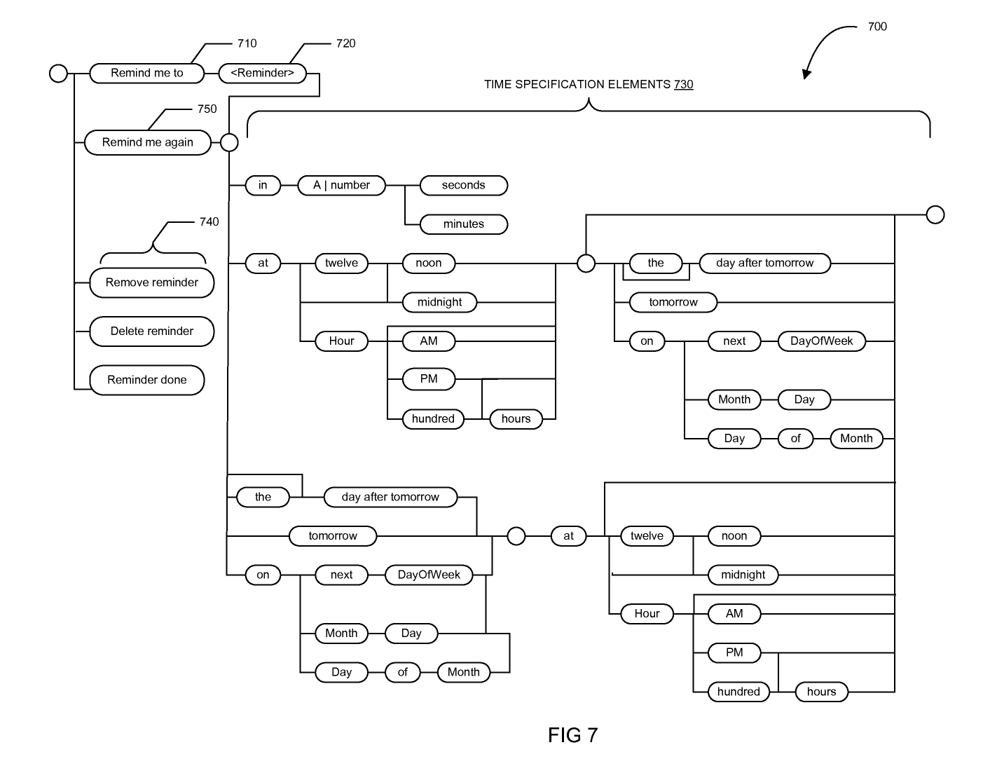

FIG. 7 provides an example of a grammar that might be used to create reminders and recognize commands related to reminders.

The grammar 700 uses the reminder start phrase “Remind me to” 710 to indicate the beginning of a reminder utterance. The reminder start phrase 710 is followed by a variable length reminder phrase 720 as described above. Following the reminder phrase are elements for time specification 730. The grammar also includes commands for processing reminders 740 such as “Remove reminder”, “Delete reminder” and “Reminder done” to indicate that the reminder can be discarded from the personal voice reminder system 100. A command for delaying and replaying reminders 750 is also shown. In this example this command 750 begins with the phrase “Remind me again” and continues with the same time specification 730 as might be used to specify the original time for the rule for playback. Note that the Hour elements subsume all specification of a time within a given hour including specification of the minutes, for example “five twenty” and relative specification of time within an hour such as “quarter after five” or “quarter to six”.

FIG. 7 provides only an example of a grammar that might be used in a personal voice reminder system 100. Other grammars might include additional commands, phrasing to allow definition of repetitive or recurrent reminders, specification of locations and activities as described above, commands for the definition of locations and activities for use in rules for playback, etc.

Other advantages are evident from the discussion above.

It will also be understood that the system according to some embodiments of the present invention may be a suitably programmed computer. Likewise, some embodiments of the invention contemplate a computer program being readable by a computer for executing the method of the invention. Some embodiments of the invention further contemplate a machine-readable memory tangibly embodying a program of instructions executable by the machine for executing methods of the invention.

While the invention has been shown and described with respect to particular embodiments, it is not thus limited. Numerous modifications, changes and improvements within the scope of the invention will now occur to the reader.

1. Personal voice reminder system comprising a controller, speech recognition system, voice input element, voice output element, and storage element, wherein said controller receives voice input from the voice input element, uses the speech recognition element to extract one or more reminder criteria from the received voice input, creates rules for playback from one or more extracted reminder criteria, creates reminder messages to be played back, stores said reminders and said rules for playback in the storage element, and plays said reminders using the voice output element when said rules for playback are satisfied.

2. The system of claim 1, further comprising: a timing element, wherein said reminder criteria are based on time.

3. The system of claim 1, further comprising: using a location element to determine the location of the device; and creating a reminder criteria for entering or leaving said determined location.

4. The system of claim 3, wherein the personal voice reminder system provides a method for creating and/or configuring location definitions for use in creating said location based reminder criteria.

5. The system of claim 1, further comprising: a position and/or motion determining element.

6. The system of claim 5, further comprising: using said position and/or motion determining element to determine said user activity; and creating a reminder criteria for said determined user activity.

7. The system of claim 6, wherein the personal voice reminder system provides a method for creating and/or configuring activity definitions for use in creating said activity based reminder criteria.

8. The system of claim 5, wherein said motion and/or position determining system is used to provide commands to said personal voice reminder system to playback, record or manage said reminders.

9. The system of claim 8, wherein the personal voice reminder system provides a method for creating and/or configuring motion and/or position definitions for use in creating said motion and/or position based commands.

10. The system of claim 8, wherein said management of said reminders includes delaying said reminders when enabling motions or positions are not detected by said motion or position determining system.

11. The system of claim 5, wherein said motion or position determining system is used to enable or disable said personal voice reminder system to capture commands.

12. The system of claim 1, wherein said controller processes commands to delete or delay the activation of reminders.

13. The system of claim 1, wherein said personal voice reminder system contains a notification element used to indicate that a reminder is ready to be played back.

14. The system of claim 1, wherein the recorded reminder is stored without some or all of the reminder input used to determine the reminder criteria used to activate the reminder.

15. The system of claim 1, wherein said personal voice reminder system is implemented as a portion of a multifunction device.

16. A position controlled system comprising a controller, and a position and/or motion sensing element, wherein said controller receives position and/or motion information from said position and/or motion sensing element and uses said position and/or motion information to invoke, enable or disable functionality of the controller or additional elements not specified herein.

17. The system of claim 16, further comprising additional sensor elements used to refine the input from said position and/or motion sensing element to distinguish command inputs from non-command inputs.

18. The system of claim 16, further comprising a voice date and/or time output element wherein the controller invokes voice output of the date and/or time when the system is positioned for listening to the voice output.

19. The system of claim 16, further comprising a telephony element wherein the controller invokes call answering when the system is positioned for listening to voice output.

20. The system of claim 16, wherein the position controlled system provides a method for creating and/or configuring motion and/or position definitions for use in creating said motion and/or position based commands.
